(19) United States
(12) Patent Application Publication
(10) Pub. No.: US 2024/0362857 A1
(43) Pub. Date: Oct. 31, 2024

(54) Depth Image Generation Using a Graphics Processor for Augmented Reality

(71) Applicant: Niantic, Inc., San Francisco, CA (US)

(72) Inventors: Erik Marshall Murphy-Chutorian, Palo Alto, CA (US); Nicholas John Butko, Cupertino, CA (US)

(21) Appl. No.: 18/309,761

(22) Filed: Apr. 28, 2023

(51) Int. Cl. G06T 15/80; G06T 7/70

(52) U.S. Cl. CPC G06T 15/80; G06T 7/70

(57) ABSTRACT

An AR device displays virtual objects to users as part of an AR experience by generating a depth image by rendering the depth image from a three-dimensional (3D) world model. The AR device receives an image from a camera and estimates its physical pose in the real world when the image was captured. The AR device accesses the 3D world model and estimates a virtual pose within a 3D world model that corresponds to the estimated physical pose in the real world. The AR device uses the virtual pose to render the depth image using the 3D world model. The AR device may use a graphics processor to render the depth image from a camera view corresponding to the virtual pose. The AR device uses the depth image to present content to the user over the image captured by the camera.

### BACKGROUND

Augmented reality (“AR”) devices display virtual objects to users in a display that overlays the virtual objects on the real world. For example, an AR device may display image data to a user that shows the real-world environment around the user, but with a virtual object that is sitting on a real-world table. Augmented reality is typically a more complicated technical task than full virtual reality (where the entire image displayed to a user is virtual) because virtual objects must be integrated into the real world for the virtual objects to “feel” real to the user. For example, for an AR device to realistically display virtual objects to a user, the AR device must display the virtual object such that the virtual object appears correctly positioned relative to objects or structures within the real world. AR devices may commonly use sensor data of the environment around the user to determine how to display a virtual object such that the virtual object appears to be an actual object in the real world. For example, to display a virtual bridge over a physical road, the AR device may use sensor data to identify each side of the road and then display the virtual bridge such that it appears to cross the road.

However, sensor data can be inaccurate and often requires the AR device to interpret the sensor data to determine where objects or structures in its environment are located. Thus, an AR device must commonly expend significant computational resources to locate itself relative to objects and structures in its environment so that the AR device can present AR content. Furthermore, the AR device must further determine how to display the virtual object within an image such that the virtual object appears correctly positioned relative to both the AR device and other objects and structures within the AR device's environment. Again, since sensor data can be inaccurate and needs to be interpreted, AR devices commonly fail to realistically display virtual objects.

### SUMMARY

An AR device displays virtual objects to users as part of an AR experience by generating a depth image by rendering the depth image from a three-dimensional (3D) world model. The 3D world model is a model that describes the physical world. For example, the 3D world model may be a 3D mesh of polygons that estimate the structure of objects in a geographic region. This 3D world model may be generated based on image data from a plurality of client devices.

The AR device receives an image from a camera coupled to the AR device. The AR device estimates its physical pose in the real world when the image was captured. For example, the AR device may use visual inertial odometry (VIO) data to estimate its pose at the time when the image was captured. The AR device accesses the 3D world model and estimates a virtual pose within the 3D world model that corresponds to the estimated physical pose in the real world. The AR device uses the virtual pose to render the depth image using the 3D world model. A depth image is an image where each pixel represents a distance from the estimated physical pose of the client device to a physical object that is represented by a corresponding pixel in the received image. The AR device may use a graphics processor to render the depth image from a camera view corresponding to the virtual pose. For example, the graphics processor may apply fragment shading to render the depth image based on the 3D world model.

The AR device uses the depth image to present content to the user over the image captured by the camera (e.g., as augmented reality content). For example, the AR device may use the depth image to display a virtual object within the captured image as if the virtual object were real. To display the virtual object, the AR device accesses a virtual object to be displayed to the user. The AR device may access an image to be displayed to the user and virtual pose information of the object within the 3D world model. The AR device modifies the captured image to display the virtual object such that the virtual object appears to be located at a physical location. In other words, the AR device modifies the captured image such that the virtual object appears to be actually located within the real world.

By using the 3D world model, the AR device can render the depth image using a graphics processor. The AR device can thereby more efficiently generate the depth image using parallel processing capabilities of the graphics processor. Furthermore, the 3D world model is more likely to accurately represent the physical world than sensor data captured by the AR device in real time. Therefore, the AR device can more effectively display AR content to a user.

### BRIEF DESCRIPTION OF THE DRAWINGS

FIG. 1 depicts a representation of a virtual world having a geography that parallels the real world, according to one embodiment.

FIG. 2 depicts an exemplary game interface of a parallel reality game, according to one embodiment.

FIG. 3 is a block diagram of a networked computing environment suitable for generating depth images for augmented reality, according to one embodiment.

FIG. 4 is a flowchart of a process for generating depth images for augmented reality, according to one embodiment.

FIG. 5 illustrates example corresponding image pixels and depth pixels for an image of an object, according to one embodiment.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

Various embodiments are described in the context of a parallel reality game that includes augmented reality content in a virtual world geography that parallels at least a portion of the real-world geography such that player movement and actions in the real-world affect actions in the virtual world. The subject matter described is applicable in other situations where providing AR content is desirable. In addition, the inherent flexibility of computer-based systems allows for a great variety of possible configurations, combinations, and divisions of tasks and functionality between and among the components of the system.

### Example Location-Based Parallel Reality Game

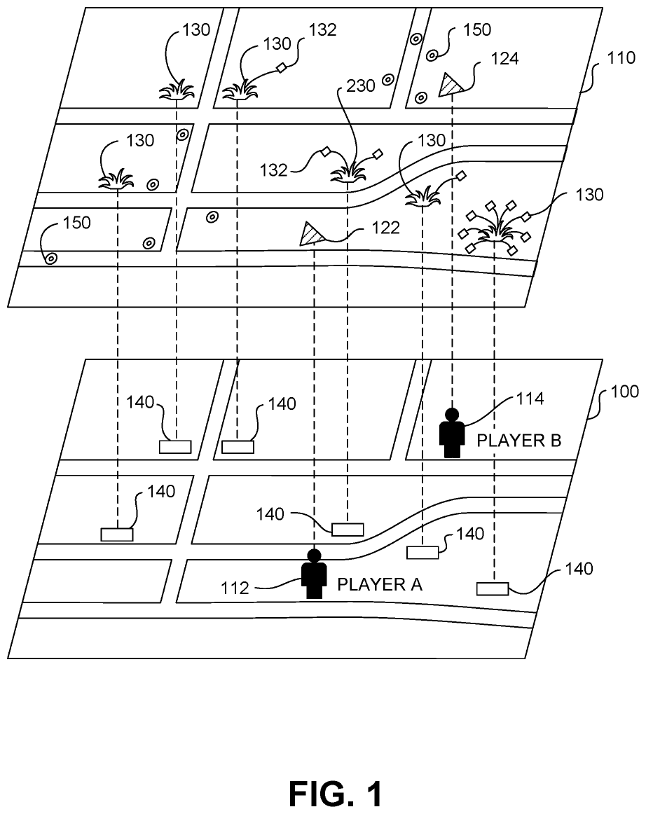

FIG. 1 is a conceptual diagram of a virtual world 110 that parallels the real world 100. The virtual world 110 can act as the game board for players of a parallel reality game. As illustrated, the virtual world 110 includes a geography that parallels the geography of the real world 100. In particular, a range of coordinates defining a geographic area or space in the real world 100 is mapped to a corresponding range of coordinates defining a virtual space in the virtual world 110. The range of coordinates in the real world 100 can be associated with a town, neighborhood, city, campus, locale, a country, continent, the entire globe, or other geographic area. Each geographic coordinate in the range of geographic coordinates is mapped to a corresponding coordinate in a virtual space in the virtual world 110.

A player's position in the virtual world 110 corresponds to the player's position in the real world 100. For instance, player A located at position 112 in the real world 100 has a corresponding position 122 in the virtual world 110. Similarly, player B located at position 114 in the real world 100 has a corresponding position 124 in the virtual world 110. As the players move about in a range of geographic coordinates in the real world 100, the players also move about in the range of coordinates defining the virtual space in the virtual world 110. In particular, a positioning system (e.g., a GPS system, a localization system, or both) associated with a mobile computing device carried by the player can be used to track a player's position as the player navigates the range of geographic coordinates in the real world 100. Data associated with the player's position in the real world 100 is used to update the player's position in the corresponding range of coordinates defining the virtual space in the virtual world 110. In this manner, players can navigate along a continuous track in the range of coordinates defining the virtual space in the virtual world 110 by simply traveling among the corresponding range of geographic coordinates in the real world 100 without having to check in or periodically update location information at specific discrete locations in the real world 100.

The location-based game can include game objectives requiring players to travel to or interact with various virtual elements or virtual objects scattered at various virtual locations in the virtual world 110. A player can travel to these virtual locations by traveling to the corresponding location of the virtual elements or objects in the real world 100. For instance, a positioning system can track the position of the player such that as the player navigates the real world 100, the player also navigates the parallel virtual world 110. The player can then interact with various virtual elements and objects at the specific location to achieve or perform one or more game objectives.

A game objective may have players interacting with virtual elements 130 located at various virtual locations in the virtual world 110. These virtual elements 130 can be linked to landmarks, geographic locations, or objects 140 in the real world 100. The real-world landmarks or objects 140 can be works of art, monuments, buildings, businesses, libraries, museums, or other suitable real-world landmarks or objects. Interactions include capturing, claiming ownership of, using some virtual item, spending some virtual currency, etc. To capture these virtual elements 130, a player travels to the landmark or geographic locations 140 linked to the virtual elements 130 in the real world and performs any necessary interactions (as defined by the game's rules) with the virtual elements 130 in the virtual world 110. For example, player A may have to travel to a landmark 140 in the real world 100 to interact with or capture a virtual element 130 linked with that particular landmark 140. The interaction with the virtual element 130 can require action in the real world, such as taking a photograph or verifying, obtaining, or capturing other information about the landmark or object 140 associated with the virtual element 130.

Game objectives may require that players use one or more virtual items that are collected by the players in the location-based game. For instance, the players may travel the virtual world 110 seeking virtual items 132 (e.g. weapons, creatures, power ups, or other items) that can be useful for completing game objectives. These virtual items 132 can be found or collected by traveling to different locations in the real world 100 or by completing various actions in either the virtual world 110 or the real world 100 (such as interacting with virtual elements 130, battling non-player characters or other players, or completing quests, etc.). In the example shown in FIG. 1, a player uses virtual items 132 to capture one or more virtual elements 130. In particular, a player can deploy virtual items 132 at locations in the virtual world 110 near to or within the virtual elements 130. Deploying one or more virtual items 132 in this manner can result in the capture of the virtual element 130 for the player or for the team/faction of the player.

In one particular implementation, a player may have to gather virtual energy as part of the parallel reality game. Virtual energy 150 can be scattered at different locations in the virtual world 110. A player can collect the virtual energy 150 by traveling to (or within a threshold distance of) the location in the real world 100 that corresponds to the location of the virtual energy in the virtual world 110. The virtual energy 150 can be used to power virtual items or perform various game objectives in the game. A player that loses all virtual energy 150 may be disconnected from the game or prevented from playing for a certain amount of time or until they have collected additional virtual energy 150.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing their locations.

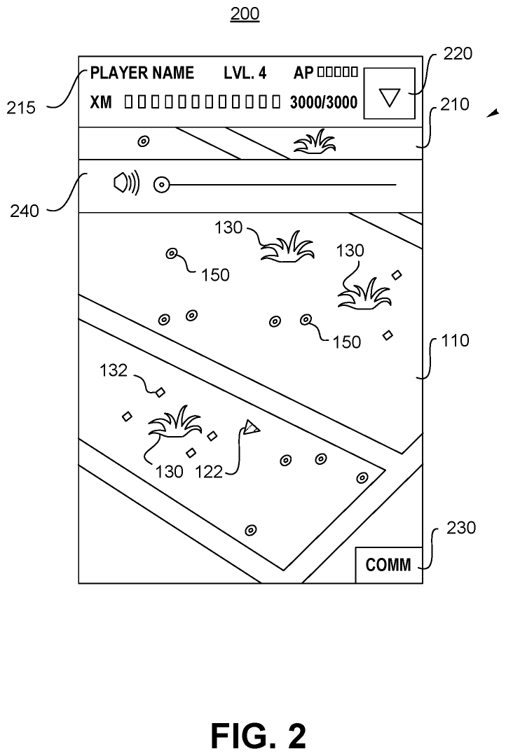

FIG. 2 depicts one embodiment of a game interface 200 that can be presented (e.g., on a player's smartphone) as part of the interface between the player and the virtual world 110. The game interface 200 includes a display window 210 that can be used to display the virtual world 110 and various other aspects of the game, such as player position 122 and the locations of virtual elements 130, virtual items 132, and virtual energy 150 in the virtual world 110. The user interface 200 can also display other information, such as game data information, game communications, player information, client location verification instructions and other information associated with the game. For example, the user interface can display player information 215, such as player name, experience level, and other information. The user interface 200 can include a menu 220 for accessing various game settings and other information associated with the game. The user interface 200 can also include a communications interface 230 that enables communications between the game system and the player and between one or more players of the parallel reality game.

According to aspects of the present disclosure, a player can interact with the parallel reality game by carrying a client device around in the real world. For instance, a player can play the game by accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 200 can include non-visual elements that allow a user to interact with the game. For instance, the game interface can provide audible notifications to the player when the player is approaching a virtual element or object in the game or when an important event happens in the parallel reality game. In some embodiments, a player can control these audible notifications with audio control 240. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. Players may also be able to obtain enhanced “powers” or virtual items that can be used to complete game objectives within the game.

Those of ordinary skill in the art, using the disclosures provided, will appreciate that numerous game interface configurations and underlying functionalities are possible. The present disclosure is not intended to be limited to any one particular configuration unless it is explicitly stated to the contrary.

### Example Gaming System

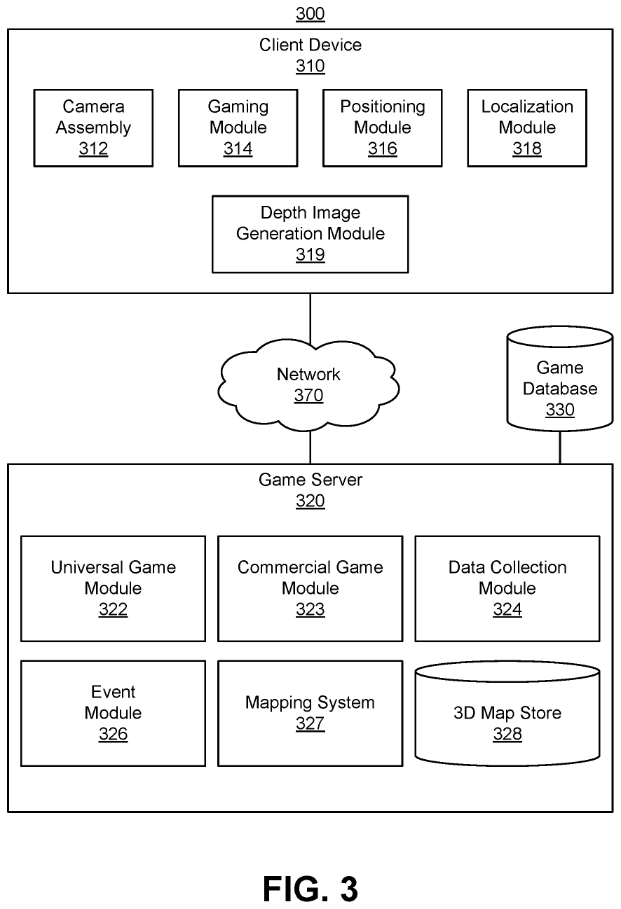

FIG. 3 illustrates one embodiment of a networked computing environment 300. The networked computing environment 300 uses a client-server architecture, where a game server 320 communicates with a client device 310 over a network 370 to provide a parallel reality game to a player at the client device 310. The networked computing environment 300 also may include other external systems such as sponsor/advertiser systems or business systems. Although only one client device 310 is shown in FIG. 3, any number of client devices 310 or other external systems may be connected to the game server 320 over the network 370. Furthermore, the networked computing environment 300 may contain different or additional elements and functionality may be distributed between the client device 310 and the server 320 in different manners than described below.

The networked computing environment 300 provides for the interaction of players in a virtual world having a geography that parallels the real world. In particular, a geographic area in the real world can be linked or mapped directly to a corresponding area in the virtual world. A player can move about in the virtual world by moving to various geographic locations in the real world. For instance, a player's position in the real world can be tracked and used to update the player's position in the virtual world. Typically, the player's position in the real world is determined by finding the location of a client device 310 through which the player is interacting with the virtual world and assuming the player is at the same (or approximately the same) location. For example, in various embodiments, the player may interact with a virtual element if the player's location in the real world is within a threshold distance (e.g., ten meters, twenty meters, etc.) of the real-world location that corresponds to the virtual location of the virtual element in the virtual world. For convenience, various embodiments are described with reference to “the player's location” but one of skill in the art will appreciate that such references may refer to the location of the player's client device 310.

A client device 310 can be any portable computing device capable for use by a player to interface with the game server 320. For instance, a client device 310 is preferably a portable wireless device that can be carried by a player, such as a smartphone, portable gaming device, augmented reality (AR) headset, cellular phone, tablet, personal digital assistant (PDA), navigation system, handheld GPS system, or other such device. For some use cases, the client device 310 may be a less-mobile device such as a desktop or a laptop computer. Furthermore, the client device 310 may be a vehicle with a built-in computing device.

The client device 310 communicates with the game server 320 to provide sensory data of a physical environment. In one embodiment, the client device 310 includes a camera assembly 312, a gaming module 314, positioning module 316, localization module 318, and a depth image generation module 319. The client device 310 also includes a network interface (not shown) for providing communications over the network 370. In various embodiments, the client device 310 may include different or additional components, such as additional sensors, display, and software modules, etc.

The camera assembly 312 includes one or more cameras which can capture image data. The cameras capture image data describing a scene of the environment surrounding the client device 310 with a particular pose (the location and orientation of the camera within the environment). The camera assembly 312 may use a variety of photo sensors with varying color capture ranges and varying capture rates. Similarly, the camera assembly 312 may include cameras with a range of different lenses, such as a wide-angle lens or a telephoto lens. The camera assembly 312 may be configured to capture single images or multiple images as frames of a video.

The client device 310 may also include additional sensors for collecting data regarding the environment surrounding the client device, such as movement sensors, accelerometers, gyroscopes, barometers, thermometers, light sensors, microphones, etc. The image data captured by the camera assembly 312 can be appended with metadata describing other information about the image data, such as additional sensory data (e.g. temperature, brightness of environment, air pressure, location, pose etc.) or capture data (e.g. exposure length, shutter speed, focal length, capture time, etc.).

The gaming module 314 provides a player with an interface to participate in the parallel reality game. The game server 320 transmits game data over the network 370 to the client device 310 for use by the gaming module 314 to provide a local version of the game to a player at locations remote from the game server. In one embodiment, the gaming module 314 presents a user interface on a display of the client device 310 that depicts a virtual world (e.g. renders imagery of the virtual world) and allows a user to interact with the virtual world to perform various game objectives. In some embodiments, the gaming module 314 presents images of the real world (e.g., captured by the camera assembly 312) augmented with virtual elements from the parallel reality game. In these embodiments, the gaming module 314 may generate or adjust virtual content according to other information received from other components of the client device 310. For example, the gaming module 314 may adjust a virtual object to be displayed on the user interface according to a depth map of the scene captured in the image data.

The gaming module 314 can also control various other outputs to allow a player to interact with the game without requiring the player to view a display screen. For instance, the gaming module 314 can control various audio, vibratory, or other notifications that allow the player to play the game without looking at the display screen.

The positioning module 316 can be any device or circuitry for determining the position of the client device 310. For example, the positioning module 316 can determine actual or relative position by using a satellite navigation positioning system (e.g. a GPS system, a Galileo positioning system, the Global Navigation satellite system (GLONASS), the BeiDou Satellite Navigation and Positioning system), an inertial navigation system, a dead reckoning system, IP address analysis, triangulation and/or proximity to cellular towers or Wi-Fi hotspots, or other suitable techniques.

As the player moves around with the client device 310 in the real world, the positioning module 316 tracks the position of the player and provides the player position information to the gaming module 314. The gaming module 314 updates the player position in the virtual world associated with the game based on the actual position of the player in the real world. Thus, a player can interact with the virtual world simply by carrying or transporting the client device 310 in the real world. In particular, the location of the player in the virtual world can correspond to the location of the player in the real world. The gaming module 314 can provide player position information to the game server 320 over the network 370. In response, the game server 320 may enact various techniques to verify the location of the client device 310 to prevent cheaters from spoofing their locations. It should be understood that location information associated with a player is utilized only if permission is granted after the player has been notified that location information of the player is to be accessed and how the location information is to be utilized in the context of the game (e.g. to update player position in the virtual world). In addition, any location information associated with players is stored and maintained in a manner to protect player privacy.

The localization module 318 receives the location determined for the client device 310 by the positioning module 316 and refines it by determining a pose of one or more cameras of the camera assembly 312. In one embodiment, the localization module 318 uses the location generated by the positioning module 316 to select a 3D map of the environment surrounding the client device 310. The localization module 318 may obtain the 3D map from local storage or from the game server 320. The 3D map may be a point cloud, mesh, or any other suitable 3D representation of the environment surrounding the client device 310.

In one embodiment, the localization module 318 applies a trained model to determine the pose of images captured by the camera assembly 312 relative to the 3D map. Thus, the localization model can determine an accurate (e.g., to within a few centimeters and degrees) determination of the position and orientation of the client device 310. The position of the client device 310 can then be tracked over time using dead reckoning based on sensor readings, periodic re-localization, or a combination of both. Having an accurate pose for the client device 310 may enable the gaming module 314 to present virtual content overlaid on images of the real world (e.g., by displaying virtual elements in conjunction with a real-time feed from the camera assembly 312 on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly.

The depth image generation module 319 generates depth images for images captured by the client device 310 (e.g., by camera assembly 312). The depth image generation module 319 generates the depth images by rendering the depth image from a 3D world model that represents the physical world. These depth images include depth pixels that map onto image pixels in captured images from a camera, where each depth pixel indicates a distance away from the client device 310 of the object that is represented by the corresponding image pixel. More details describing methods for generating depth images are described in further detail below.

The game server 320 includes one or more computing devices that provide game functionality to the client device 310. The game server 320 can include or be in communication with a game database 330. The game database 330 stores game data used in the parallel reality game to be served or provided to the client device 310 over the network 370.

The game data stored in the game database 330 can include: (1) data associated with the virtual world in the parallel reality game (e.g. imagery data used to render the virtual world on a display device, geographic coordinates of locations in the virtual world, etc.); (2) data associated with players of the parallel reality game (e.g. player profiles including but not limited to player information, player experience level, player currency, current player positions in the virtual world/real world, player energy level, player preferences, team information, faction information, etc.); (3) data associated with game objectives (e.g. data associated with current game objectives, status of game objectives, past game objectives, future game objectives, desired game objectives, etc.); (4) data associated with virtual elements in the virtual world (e.g. positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g. location of real-world objects/landmarks, description of real-world objects/landmarks, relevance of virtual elements linked to real-world objects, etc.); (6) game status (e.g. current number of players, current status of game objectives, player leaderboard, etc.); (7) data associated with player actions/input (e.g. current player positions, past player positions, player moves, player input, player queries, player communications, etc.); or (8) any other data used, related to, or obtained during implementation of the parallel reality game. The game data stored in the game database 330 can be populated either offline or in real time by system administrators or by data received from users (e.g., players), such as from a client device 310 over the network 370.

In one embodiment, the game server 320 is configured to receive requests for game data from a client device 310 (for instance via remote procedure calls (RPCs)) and to respond to those requests via the network 370. The game server 320 can encode game data in one or more data files and provide the data files to the client device 310. In addition, the game server 320 can be configured to receive game data (e.g. player positions, player actions, player input, etc.) from a client device 310 via the network 370. The client device 310 can be configured to periodically send player input and other updates to the game server 320, which the game server uses to update game data in the game database 330 to reflect any and all changed conditions for the game.

In the embodiment shown in FIG. 3, the game server 320 includes a universal game module 322, a commercial game module 323, a data collection module 324, an event module 326, a mapping system 327, and a 3D map 328. As mentioned above, the game server 320 interacts with a game database 330 that may be part of the game server or accessed remotely (e.g., the game database 330 may be a distributed database accessed via the network 370). In other embodiments, the game server 320 contains different or additional elements. In addition, the functions may be distributed among the elements in a different manner than described.

The universal game module 322 hosts an instance of the parallel reality game for a set of players (e.g., all players of the parallel reality game) and acts as the authoritative source for the current status of the parallel reality game for the set of players. As the host, the universal game module 322 generates game content for presentation to players (e.g., via their respective client devices 310). The universal game module 322 may access the game database 330 to retrieve or store game data when hosting the parallel reality game. The universal game module 322 may also receive game data from client devices 310 (e.g. depth information, player input, player position, player actions, landmark information, etc.) and incorporates the game data received into the overall parallel reality game for the entire set of players of the parallel reality game. The universal game module 322 can also manage the delivery of game data to the client device 310 over the network 370. In some embodiments, the universal game module 322 also governs security aspects of the interaction of the client device 310 with the parallel reality game, such as securing connections between the client device and the game server 320, establishing connections between various client devices, or verifying the location of the various client devices 310 to prevent players cheating by spoofing their location.

The commercial game module 323 can be separate from or a part of the universal game module 322. The commercial game module 323 can manage the inclusion of various game features within the parallel reality game that are linked with a commercial activity in the real world. For instance, the commercial game module 323 can receive requests from external systems such as sponsors/advertisers, businesses, or other entities over the network 370 to include game features linked with commercial activity in the real world. The commercial game module 323 can then arrange for the inclusion of these game features in the parallel reality game on confirming the linked commercial activity has occurred. For example, if a business pays the provider of the parallel reality game an agreed upon amount, a virtual object identifying the business may appear in the parallel reality game at a virtual location corresponding to a real-world location of the business (e.g., a store or restaurant).

The data collection module 324 can be separate from or a part of the universal game module 322. The data collection module 324 can manage the inclusion of various game features within the parallel reality game that are linked with a data collection activity in the real world. For instance, the data collection module 324 can modify game data stored in the game database 330 to include game features linked with data collection activity in the parallel reality game. The data collection module 324 can also analyze data collected by players pursuant to the data collection activity and provide the data for access by various platforms.

The event module 326 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game.

The mapping system 327 generates a 3D map of a geographical region based on a set of images. The 3D map may be a point cloud, polygon mesh, or any other suitable representation of the 3D geometry of the geographical region. The 3D map may include semantic labels providing additional contextual information, such as identifying objects tables, chairs, clocks, lampposts, trees, etc.), materials (concrete, water, brick, grass, etc.), or game properties (e.g., traversable by characters, suitable for certain in-game actions, etc.). In one embodiment, the mapping system 327 stores the 3D map along with any semantic/contextual information in the 3D map store 328. The 3D map may be stored in the 3D map store 328 in conjunction with location information (e.g., GPS coordinates of the center of the 3D map, a ringfence defining the extent of the 3D map, or the like). Thus, the game server 320 can provide the 3D map to client devices 310 that provide location data indicating they are within or near the geographic area covered by the 3D map.

The network 370 can be any type of communications network, such as a local area network (e.g. intranet), wide area network (e.g. Internet), or some combination thereof. The network can also include a direct connection between a client device 310 and the game server 320. In general, communication between the game server 320 and a client device 310 can be carried via a network interface using any type of wired or wireless connection, using a variety of communication protocols (e.g. TCP/IP, HTTP, SMTP, FTP), encodings or formats (e.g. HTML, XML, JSON), or protection schemes (e.g. VPN, secure HTTP, SSL).

This disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, processes disclosed as being implemented by a server may be implemented using a single server or multiple servers working in combination. Databases and applications may be implemented on a single system or distributed across multiple systems. Distributed components may operate sequentially or in parallel.

In situations in which the systems and methods disclosed access and analyze personal information about users, or make use of personal information, such as location information, the users may be provided with an opportunity to control whether programs or features collect the information and control whether or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

### Example Method for Generating a Depth Image

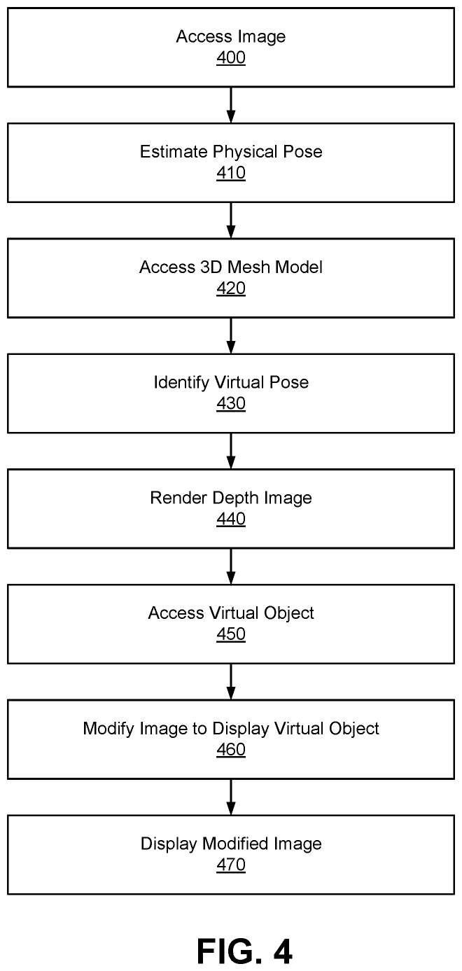

FIG. 4 is a flowchart describing an example method of generating a depth image for displaying a virtual object within an image, according to one embodiment. The steps of FIG. 4 are illustrated from the perspective of a client device (e.g., client device 310) performing the method. However, some or all of the steps may be performed by other entities or components (e.g., game server 320). In addition, some embodiments may perform the steps in parallel, perform the steps in different orders, or perform different steps.

The client device accesses 400 an image captured by a camera of the computing device. The image has a plurality of image pixels, where each pixel includes one or more values for depicting the image. For example, each image pixel may have a single value (e.g., for a grayscale image) or may have multiple values (e.g., different values for different channels in a red-green-blue (RGB) color space or a hue-saturation-brightness (HSB) color space). The image may be a single still image or may be a frame as part of a video captured by the camera.

The client device estimates 410 its physical pose when the image was captured. The device's physical pose represents the client device's location and orientation within the physical world. For example, the client device's location may be GPS coordinates and the client device's orientation may be based on the cardinal direction the client device is facing and an angle above or below the horizon that the client device is tilted. The client device may use visual inertial odometry (VIO) to determine its pose. For example, the client device may receive VIO data from a sensor coupled to the client device and may estimate a pose of the client device based on the VIO data. The client device may also determine its pose based on location data, such as GPS data, collected when the client device captured the image. Note that while the camera is primarily described as being physically coupled to the client device, in some embodiments, the camera is physically separated from the client device, and the client device estimates a pose of the camera when the image was captured.

The client device accesses 420 a three-dimensional (3D) world model that describes the physical world. For example, the 3D world model may describe the structure of objects within the physical world. The 3D world model may use a mesh to model the physical world. This mesh uses a set of polygons (e.g., triangles) to approximate the structure of objects in the physical world. The 3D world model may be stored by an online server (e.g., game server 320) and accessed by the client device through a network. In some embodiments, the 3D world model has sub models that each represent a different geographic region. When accessing the 3D world model, the client device may identify a sub model of the 3D world model that corresponds to a geographic region that includes the physical pose of the client device, and access that identified sub model.

In some embodiments, the 3D world model is built based on additional images from a plurality of client devices corresponding to users of an online system (e.g., a game server). The online system may receive image data representing a first area around a first client device. The online system generates a first model of the first area based on the image data. The online system receives image data representing a second area around a second client device, and similarly generates a second model of the second area based on that image data. The online system identifies a common feature in the first model and the second model and links the models together based on the common feature. For example, if the online system identifies a store front in the first model and the same store front in the second model, the online system may link combine the first model and the second model together to generate a combined model by using the store front as a common reference point in both models. The online system may use GPS and IMU data to align the 3D world model with the physical world, thereby mapping the 3D structures represented by the 3D world model onto the physical world. U.S. patent application Ser. No. 17/127,199, filed Dec. 18, 2020, describes example methods for merging local models together from different devices, and is incorporated by reference. In some embodiments, the additional images from which the 3D world model is built includes an image captured by the client device.

The client device identifies 430 a virtual pose within the 3D world model that corresponds to the estimated physical pose of the client device in the real world. The client device may identify the virtual pose by using a reference point in the 3D world model that corresponds to a known reference point in the real world. For example, the 3D world model may store a reference point that corresponds to a particular location or landmark within the physical world. The client device may determine the estimated pose's position relative to that location or landmark, and thereby identify the virtual pose of the client device within the 3D world model. In some embodiments, the client device identifies a virtual camera view within the 3D world based on the virtual pose.

The client device renders 440 a depth image based on the virtual pose and the 3D world model. A depth image is an image where each pixel represents a distance from the estimated physical pose of the client device to a physical object that is represented by a corresponding pixel in the received image. Thus, the depth image has the same number of pixels as the image captured by the camera of the client device.

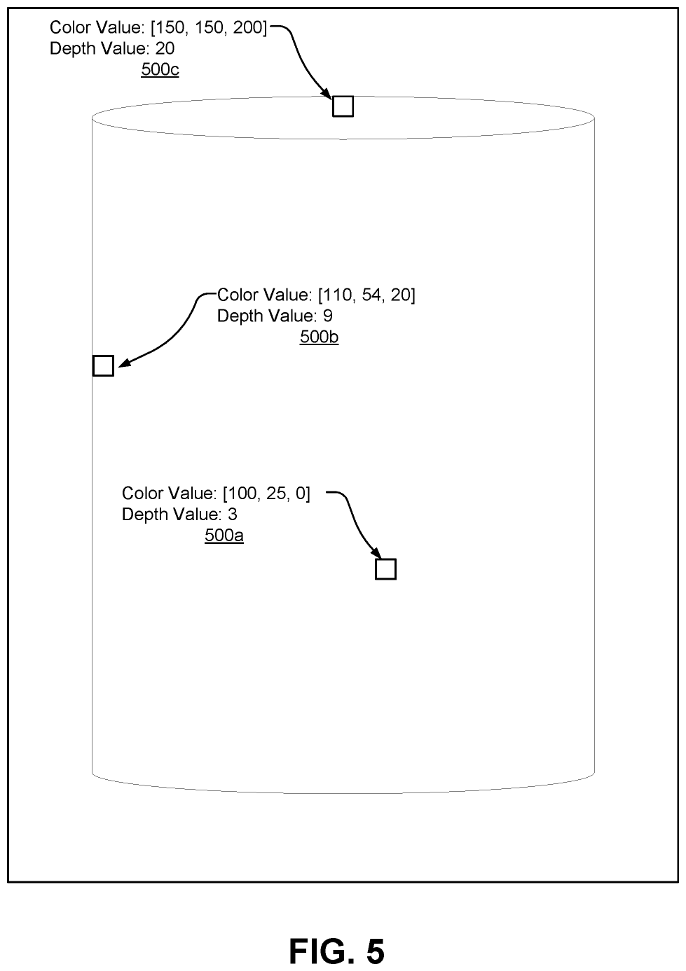

FIG. 5 illustrates example corresponding image pixels and depth pixels for an image of an object, in accordance with some embodiments. FIG. 5 illustrates three example pixel locations and depicts the color values for the image pixel and depth value for the depth pixel that correspond to those locations. For example, at location 500a, the image pixel at that location has color values [100, 25, 0], which may be RGB values for the pixel, and the depth pixel at location 500a has a depth value of 3. At location 500b, the image pixel has color values [110, 54, 20] and the depth pixel has a depth value of 9. Thus, the depth image indicates that the image pixel at location 500a is depicting a closer portion of the object than the image pixel at location 500b. Similarly, since the depth value of the depth pixel at 500c is 20, the image pixel at location 500c is depicting a portion of the object that is farther away than the ones at locations 500a or 500b.

The client device renders the depth image using a graphics processor of the client device. A graphics processor (e.g., a graphics processing unit or “GPU”) is a specialized electronic circuit designed to manipulate and alter memory to accelerate the creation of images in a frame buffer intended for output to a display device. A graphics processor typically contains a large number of small processing units called “cores” that work together to perform calculations in parallel. The graphics processor may also have dedicated memory to support its processing functions, and can communicate with other components in a computer system (e.g., a central processing unit) through a variety of interfaces, including PCI Express and High Bandwidth Memory (HBM).

The graphics processor may generate the depth image by rendering the depth image from the virtual pose of the client device within the 3D world model. For example, the graphics processor may use a 3D mesh stored by the 3D world model to render a depth image. In some embodiments, the graphics processor applies fragment shading to render the depth image from the 3D world model.

The client device may use the depth image to present content to a user over the image captured by the camera. For example, the client device may use the depth image to display a virtual object within the captured image as if the virtual object were real. To display the virtual object, the client device accesses 450 a virtual object to be displayed to the user. The client device may access an image to be displayed to the user and virtual pose information of the object within the 3D world model. The client device modifies 460 the captured image to display the virtual object such that the virtual object appears to be located at a physical location. In other words, the client device modifies the captured image such that the virtual object appears to be actually located within the real world.

The client device displays 470 the modified image to the user through a display of the client device. For example, where the client device is a smartphone or a tablet, the client device may display the modified image on a screen. Similarly, if the client device is a virtual or augmented reality headset, the client device displays the modified image to the user through projectors of the client device that are used to present virtual or augmented reality content to the user.

In some embodiments, the client device generates a depth image that has a different number of pixels from the image captured by the camera. In these embodiments, the client device may use interpolation techniques to compute a corresponding depth value for an image pixel in the captured image based on the depth image pixels. The client device may compute a composite depth value for an image pixel of the captured image based on a set of depth pixels of the depth image that are positioned within the depth image near a position that corresponds to the image pixel's position within the captured image. The client device may use nearest neighbor interpolation, linear interpolation, or bicubic interpolation to compute a depth value for an image pixel of the image. The client device may compute a new depth image with the same number of pixels as the captured image based on the depth image with the different number of pixels, or may compute the depth value for only those image pixels for which the client device uses the depth value for modifying the captured image.

In some embodiments, the client device uses the depth image as an input to a VIO system that the client device uses to estimate its pose. For example, the VIO system may compute an initial estimated pose of the client device without a depth image and use that initial estimated pose to compute the depth image. For subsequent pose estimations, the client device may use the rendered depth image as an input to the VIO system to improve the efficiency or accuracy of the VIO's pose estimation.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate+/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by the following claims.

What is claimed is:

1. A computer-implemented method comprising:
accessing an image captured by a camera of a computing device, wherein the image comprises image pixels;
estimating a physical pose of the computing device when the image was captured based on visual inertial odometry data describing the physical pose of the computing device;
accessing a 3D world model for a geographic region that contains the physical pose of the computing device, wherein the 3D world model represents objects within the geographic region using a three-dimensional mesh that is generated based on additional images captured by cameras of other computing devices;
identifying a virtual pose within the 3D world model that corresponds to the physical pose of the computing device;
rendering, using a graphics processor of the computing device, a depth image corresponding to the accessed image, the depth image comprising depth pixels, each depth pixel corresponding to an image pixel of the accessed image, wherein a depth pixel represents a distance from the physical pose of the computing device to a physical object that corresponds to the corresponding image pixel in the accessed image;
accessing a virtual object to display to a user;
modifying, based on the depth image, the accessed image to include the virtual object, wherein the accessed image is modified such that the virtual object appears in the modified image to be located at a physical location; and
causing display of the modified image on a display of the computing device.

2. The method of claim 1, wherein the accessed image is a frame of a video feed.

3. The method of claim 1, wherein each image pixel of the image pixels comprises a value for a red channel, a value for a green channel, and a value for a blue channel.

4. The method of claim 1, wherein estimating the physical pose of the computing device comprises:
estimating the physical pose of the computing device based on location data describing a location of the computing device within the physical world.

5. The method of claim 1, wherein accessing the 3D world model comprises:
requesting the 3D world model from an online server.

6. The method of claim 1, wherein accessing the 3D world model comprises:
identifying the geographic region that contains the physical pose of the computing device; and
identifying a sub model of the 3D world model that corresponds to the identified geographic region.

7. The method of claim 1, further comprising:
accessing another image captured by the camera of the computing device; and
estimating another physical pose of the computing device when the other image was captured based on additional visual inertial odometry data describing the other physical pose of the computing device, wherein the additional inertial odometry data comprises the depth image.

8. The method of claim 1, wherein the additional images comprise an image captured by the camera of the computing device.

9. The method of claim 1, wherein identifying the virtual pose within the 3D world model comprises:
identifying a virtual camera view corresponding to the virtual pose from which the depth image is rendered.

10. The method of claim 1, wherein rendering the depth image comprising:
applying fragment shading to the 3D world model based on the virtual pose.

11. A non-transitory computer-readable medium storing instructions that, when executed by a processor, cause the processor to perform operations comprising:
accessing an image captured by a camera of a computing device, wherein the image comprises image pixels;
estimating a physical pose of the computing device when the image was captured based on visual inertial odometry data describing the physical pose of the computing device;
accessing a 3D world model for a geographic region that contains the physical pose of the computing device, wherein the 3D world model represents objects within the geographic region using a three-dimensional mesh that is generated based on additional images captured by cameras of other computing devices;
identifying a virtual pose within the 3D world model that corresponds to the physical pose of the computing device;
rendering, using a graphics processor of the computing device, a depth image corresponding to the accessed image, the depth image comprising depth pixels, each depth pixel corresponding to an image pixel of the accessed image, wherein a depth pixel represents a distance from the physical pose of the computing device to a physical object that corresponds to the corresponding image pixel in the accessed image;
accessing a virtual object to display to a user;
modifying, based on the depth image, the accessed image to include the virtual object, wherein the accessed image is modified such that the virtual object appears in the modified image to be located at a physical location; and
causing display of the modified image on a display of the computing device.

12. The computer-readable medium of claim 11, wherein the accessed image is a frame of a video feed.

13. The computer-readable medium of claim 11, wherein each image pixel of the image pixels comprises a value for a red channel, a value for a green channel, and a value for a blue channel.

14. The computer-readable medium of claim 11, wherein estimating the physical pose of the computing device comprises:
estimating the physical pose of the computing device based on location data describing a location of the computing device within the physical world.

15. The computer-readable medium of claim 11, wherein accessing the 3D world model comprises:
requesting the 3D world model from an online server.

16. The method of claim 1, wherein accessing the 3D world model comprises:
identifying the geographic region that contains the physical pose of the computing device; and
identifying a sub model of the 3D world model that corresponds to the identified geographic region.

17. The computer-readable medium of claim 11, further storing instructions that, when executed by the processor, cause the processor to perform operations comprising:
accessing another image captured by the camera of the computing device; and
estimating another physical pose of the computing device when the other image was captured based on additional visual inertial odometry data describing the other physical pose of the computing device, wherein the additional inertial odometry data comprises the depth image.

18. The computer-readable medium of claim 11, wherein the additional images comprise an image captured by the camera of the computing device.

19. The computer-readable medium of claim 11, wherein identifying the virtual pose within the 3D world model comprises:
identifying a virtual camera view corresponding to the virtual pose from which the depth image is rendered.

20. The computer-readable medium of claim 11, wherein rendering the depth image comprising:
applying fragment shading to the 3D world model based on the virtual pose.
